(19) United States
(12) Patent Application Publication
(10) Pub. No.: US 2009/0083151 A1
(43) Pub. Date: Mar. 26, 2009

(54) Method Of Advertising On Postage

(76) Inventor: Martin A. Urban, Rockford, IL (US)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(21) Appl. No.: 12/023,728

(22) Filed: Jan. 31, 2008

Related U.S. Application Data
(63) Continuation-in-part of application No. 11/860,601, filed on Sep. 25, 2007.

(51) Int. Cl. G06Q 30/00

(52) U.S. Cl. 705/14

(57) ABSTRACT

A method of advertising including receiving compensation from a party and placing an advertisement of the party on postage in exchange for the compensation received to advertise for the party. Also, method of advertising including providing compensation to a postage maker and having an advertisement placed on the postage by the postage maker for the compensation provided to display the advertisement. In addition, method of advertising including correlating a party offering to a particular denomination of postage and placing an advertisement for the party offering on the particular denomination of postage to advertise the party offering.

### CROSS-REFERENCE TO RELATED PATENT APPLICATIONS

This patent application is a continuation-in-part of co-pending U.S. patent application Ser. No. 11/860,601, filed Sep. 25, 2007.

### FIELD OF THE INVENTION

This invention generally relates to advertising and, in particular, a method of delivering advertising to a mass market.

### BACKGROUND OF THE INVENTION

In broad terms, advertising is paid, one-way communication through a medium in which the sponsor is identified and the message is controlled. Advertising is conducted for numerous reasons including publicity, public relations, product placement, sponsorship, underwriting, and sales promotion.

A variety of different mediums may be used to deliver advertisements, such as, for example, television, radio, movies, magazines, newspapers, the Internet, and billboards. Indeed, advertisements appear on a variety of different objects and in a variety of different places. Advertising messages may be seen on clothing or on the seats of grocery carts, placed on the walls of an airport walkway or on the sides of buses, and heard in telephone hold messages and in-store public address systems.

To be effective, advertisements should be placed where the audience has easy and/or frequent access to that advertisement. However, finding or determining where an audience will have easy and/or frequent access may be difficult. In addition, determining the type or style of the advertisement may also prove challenging.

Advertising clients are predominantly, but not exclusively, for-profit corporations seeking to increase demand for their products or services. However, other organizations also frequently spend large sums of money on advertising, even though they do not strictly sell a product or service to the general public. These other organizations may include, for example, political parties, interest groups, religion-supporting organizations, and militaries looking for new recruits.

The advertising industry is large and growing. In the year 2005, spending on advertising exceeded $144 billion in the United States alone. That same year, worldwide advertising spending was approximately $385 billion and is projected to exceed half-a-trillion dollars by the year 2010.

In light of the above, this disclosure is generally directed to methods of advertising and providing a targeted advertisement to a mass market.

### BRIEF SUMMARY OF THE INVENTION

In one aspect, a method of advertising is provided. The method includes the steps of receiving compensation from a party and placing an advertisement of the party on postage in exchange for the compensation received to advertise for the party.

In another aspect, the method of advertising includes the steps of providing compensation to a postage maker and having an advertisement placed on the postage by the postage maker for the compensation provided to display the advertisement.

In yet another aspect, the method of advertising includes the steps of correlating a party offering to a particular denomination of postage and placing an advertisement for the party offering on the particular denomination of postage to advertise the party offering.

Other embodiments of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a flowchart of an exemplary embodiment of a method of advertising in accordance with the teachings of the present invention;

FIG. 2 is a flowchart of another embodiment of a method of advertising;

FIG. 3 is a flowchart of yet another embodiment of a method of advertising;

FIG. 4 is an illustration of the front side of a United States one dollar bill generated using the methods of FIGS. 1-3;

FIG. 5 is an illustration of the back side of the United States one dollar bill of FIG. 4 generated using the methods of FIGS. 1-3;

FIG. 6 is an illustration of the front side of a United States ten dollar bill generated using the methods of FIGS. 1-3;

FIG. 7 is an illustration of the back side of the United States ten dollar bill of FIG. 6 generated using the methods of FIGS. 1-3;

FIG. 8 is an illustration of the front side of a United States penny generated using the method of FIGS. 1-3;

FIG. 9 is an illustration of the front side of a United States nickel generated using the methods of FIGS. 1-3;

FIG. 10 is a flowchart of an exemplary embodiment of a method of advertising in accordance with the teachings of the present invention;

FIG. 11 is a flowchart of another embodiment of a method of advertising;

FIG. 12 is a flowchart of yet another embodiment of a method of advertising;

FIG. 13 is an illustration of the front side of a United States postage stamp generated using the methods of FIGS. 10-12; and

FIG. 14 is an illustration of the front side of a further United States postage stamp generated using the methods of FIGS. 10-12.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

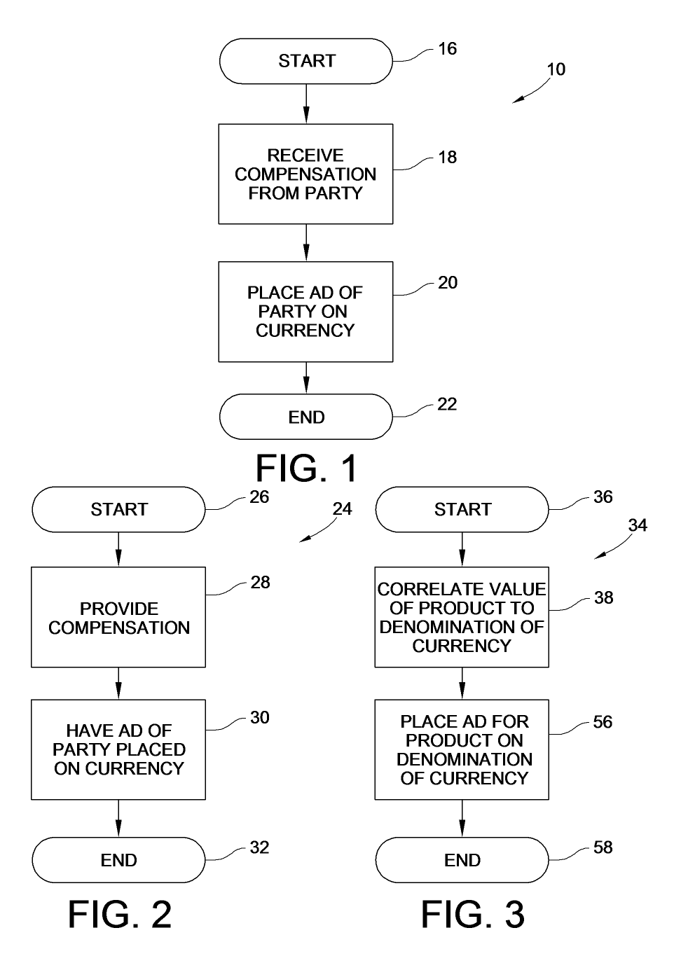

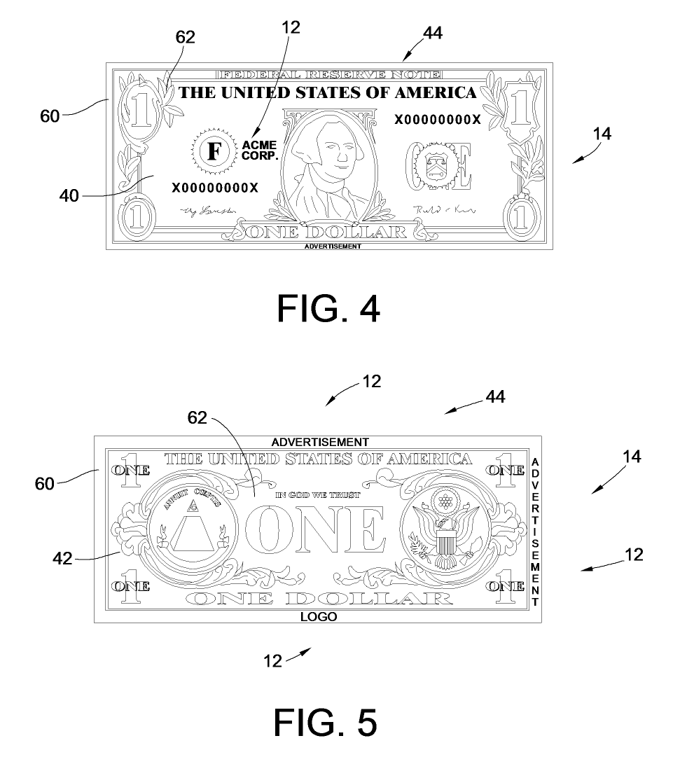

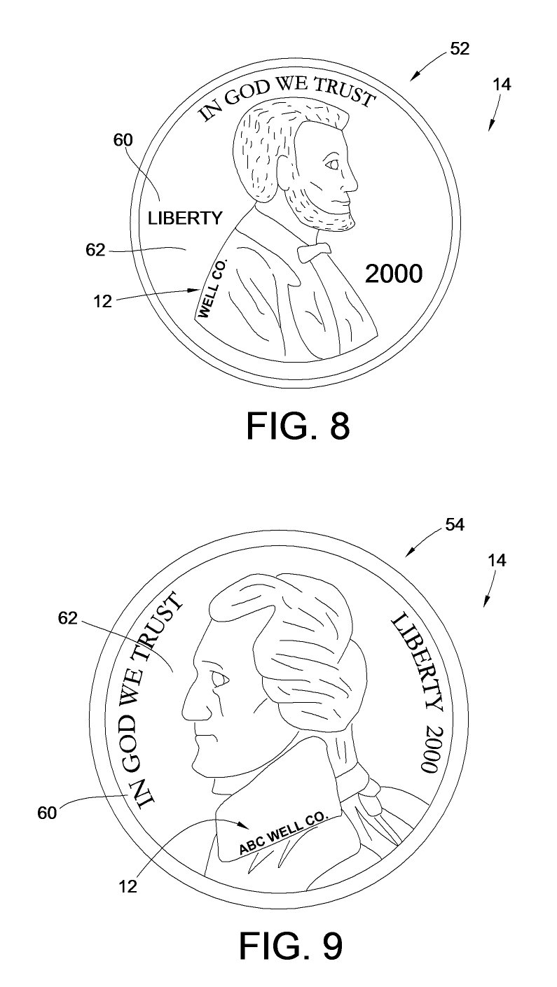

In FIGS. 1-3, methods of advertising 10, 24, 34 are illustrated. As will be more fully explained below, each method of advertising 10, 24, 34 generally relates to the placing of an advertisement 12 on currency 14 (a.k.a., money). Representative results of each method of advertising 10, 24, 34 are collectively reflected on the currency 14 depicted in FIGS. 4-9.

In the illustrated embodiment of FIG. 1, the method of advertising 10 starts 16 with the government, or some other agency authorized to make currency, receiving 18 compensation from a party. The compensation is normally monetary in nature. However, some good or service of the party or provided by the party may also be considered an acceptable form of compensation. The party is, for example, an individual, a group of individuals, a corporate entity, an agency, an institution, or some combination thereof. In that regard, the party may be an athlete, like-minded members of a group, a manufacturing company, a government agency, or a university.

After the compensation is received 18, the method of advertising 10 continues with the government or other agency placing 20 an advertisement 12 of the party on the currency in exchange for the compensation that was received to promote the party. This may include promoting a good or service offered by the party. The advertisement 12 may be placed on the currency 14 in a variety of different ways. For example, the advertisement 12 may be directly incorporated into the engraved plates or molds used to make the currency 12. In the alternative, the advertisement 12 may be printed, stamped, painted or otherwise generated on the currency 14. When printed on the currency 14, a variety of suitable printing methods (e.g., using a printing press, a laser printer, etc.) may be employed and utilized either after or as the currency 14 is produced.

After the advertisement 12 is included on the currency 14, the method ends 22 and the currency carrying the advertisement is introduced, or re-introduced, into circulation. As such, the currency 14 carrying the advertisement 12 moves through streams of commerce where the currency is likely repeatedly handled by both existing and potential customers of the party who paid for the advertisement. Therefore, the party itself, goods of the party, and/or services of the party are advertised to the mass market by the advertisement 12.

In the illustrated embodiment of FIG. 2, the method of advertising 24 starts 26 with the party providing 28 compensation to the government or some other agency authorized to make currency. After the government or other agency receives the compensation, the party has 30 their advertisement 12 placed on the currency 14 to display the advertisement. In other words, in exchange for a sufficient payment, the party is able to get their advertisement 12 placed on the currency 14 by the government or authorized money maker. Like above, after the advertisement 12 is included on the currency 14 the method 24 ends 32 and the currency carrying the advertisement is introduced, or re-introduced, into circulation.

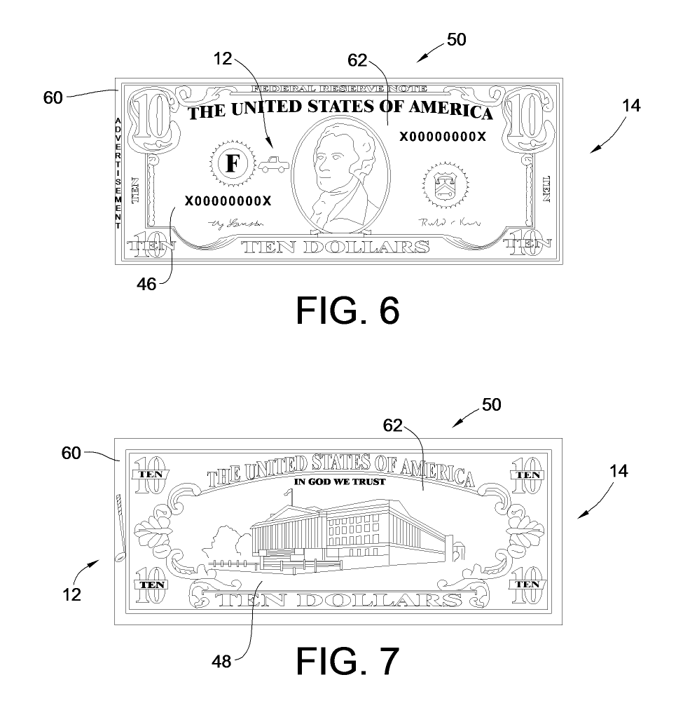

In the illustrated embodiment of FIG. 3, the method of advertising 34 starts with either the party, the government or authorized agency, or both correlating 38 a party offering (e.g., a product of the party, a service of the party, the name of the party, etc.) to a particular denomination of currency 14 to advertise the party offering. For example, if a company is selling products that cost approximately one dollar, the advertisement 12 is placed on the front and/or back side 40, 42 of a one dollar bill 44 as shown in FIGS. 4 and 5. If, however, the company is selling more expensive goods such as, for example, golf clubs or cars, the advertisement 12 is placed on the front and or back side 46, 48 of a ten dollar bill 50 as illustrated in FIGS. 6 and 7. As the value of the good, service, or name of the party increases, so does the denomination of currency 14 that carries their advertisement 12.

In the alternative, if the company is offering, for example, a wishing well cleaning service, the advertisement 12 for those services may be reflected on either side of a penny 52 or nickel 54, which are shown in FIGS. 6 and 7. In similar fashion, other denominations of currency 14 may also be provided with advertisements 12 corresponding to the value, price, or worth of the goods or services being advertised.

Referring back to FIG. 3, after the value of the product is correlated 38 to a particular denomination of currency, the government or other agency places 56 the advertisement 12 for the product on the particular denomination of currency chosen. Because the value of the product or service corresponds to the denomination of the currency 14, the advertisement 12 is selectively targeted to those customers or potential customers that may be more likely to purchase the goods or services of the company. After the advertisement 12 is included on the currency 14, the method 34 ends 58 and the currency carrying the advertisement is introduced, or re-introduced, into circulation.

Referring now to FIGS. 4-9, the currency 14 generated using the methods 10, 24, 34 of FIGS. 1-3 is shown. In FIGS. 4-9, the currency 14 is represented by United States bank notes (a.k.a., paper money) and minted coins. However, currency from other countries may also be used. As the currency 14 in FIGS. 4-9 depicts, the advertisement 12 is located in a variety of suitable location such as, for example, the margin 60 and/or the body 62 of the currency 14. Also, the advertisement 12 is vertically, horizontally, or otherwise oriented. In addition, the advertisement 12 is, for example, a logo, slogan, trademark, symbol, product, and contact information of the party. Indeed, the advertisement 12 may be anything that will draw attention to the product or service of the company.

In addition to the method steps shown in FIGS. 1-3, in one embodiment the method of advertising 10, 24, 34 includes the step of using a color for the advertisement 12. In that regard, the color of the advertisement 12 may coincide with the color of the ink or metal used to generate the currency 14. However, the color for the advertisement 12 may also be a color different from the color used to produce the currency prior to the advertisement being added. For instance, where the currency was made using only green and blank ink, the advertisement 12 may be formed using a red ink such that the advertisement is more highly visible. Likewise, where the currency 14 was minted using copper and zinc resulting in a coin with a burnt rust color, the advertisement may be formed by including a bright yellow logo on or in the coin. If desired, several different colors may be used to generate the advertisement 12 on the currency 14.

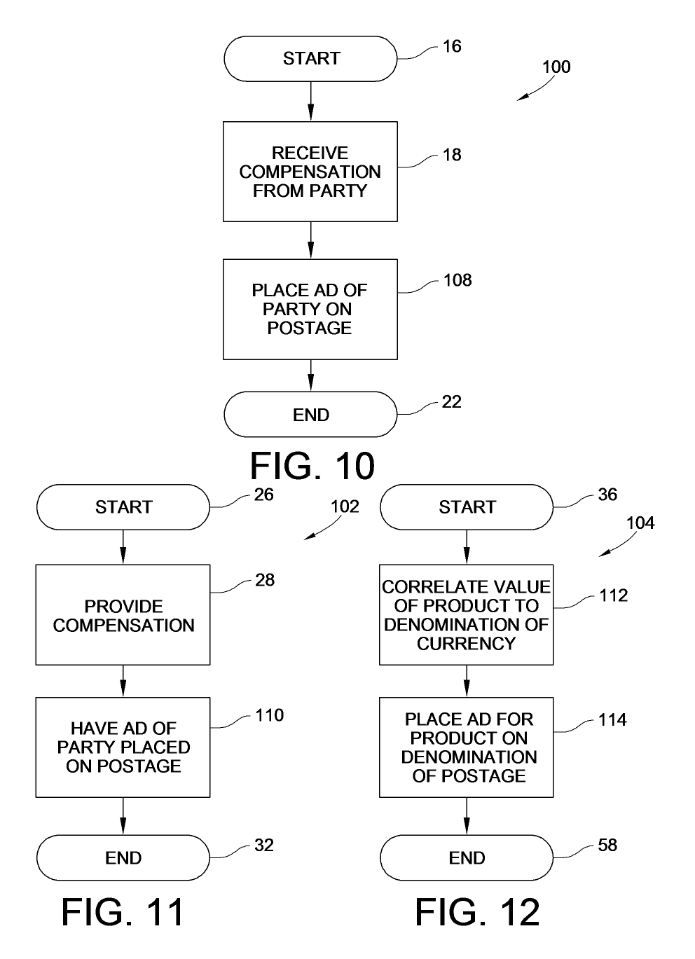

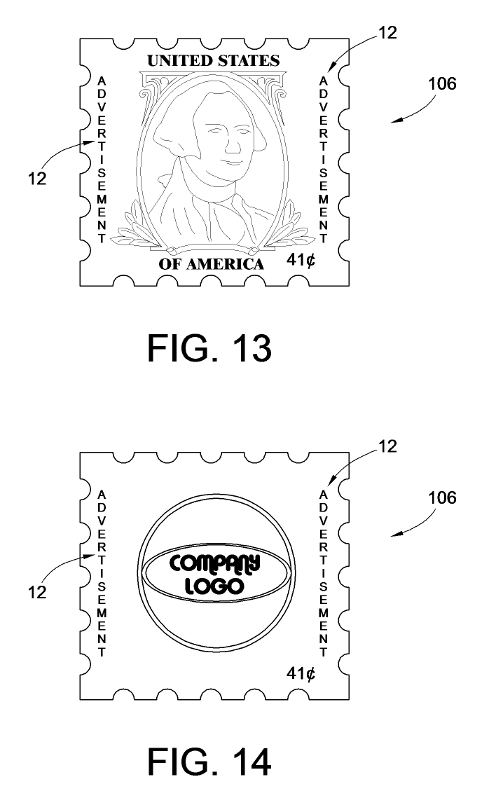

In another embodiment as depicted in FIGS. 10-12, methods of advertising 100, 102, 104 are illustrated. Each method of advertising 100, 102, 104 generally relates to the placing of the advertisement 12 on postage 106 (e.g., stamps). A representative result of each method of advertising 100, 102, 104 is reflected on the postage 106 depicted in FIGS. 13 and 14.

In the illustrated embodiment of FIGS. 10-12, the methods of advertising 100, 102, 104 are generally the same as the methods noted above for currency with a few exceptions. For example, in the method of advertising 100 of FIG. 10, the advertisement 12 of a party is placed on postage 108 instead of currency. In the method of advertising 102 of FIG. 11, the party has the advertising placed on postage 110. Finally, in the method of advertising 104 of FIG. 12, the value of a product is correlated 112 to a denomination of the postage 106 and the advertisement 12 for the product is placed 114 on the postage 106.

If desired, the advertisement 12 may be placed on the front of the postage 106 on the adhesive side of the postage, which opposes the front side. For example, the advertisement 12 on the adhesive side may advertise a particular brand of adhesive. As shown in FIG. 13, the advertisement 12 may be relegated to a margin or outer portion of the postage 106. In an effort to make the advertisement stand out and catch the attention of, for example, a consumer, the advertisement 12 may use color not employed in making the postage 106. In addition, the advertisement 12 may also be formed from lithographic printing.

From the foregoing, those skilled in the art will recognize that the methods 10, 24, 34 depicted in FIGS. 1-3 and the methods 100, 102, 104 depicted in FIGS. 10-12 permit a government or authorized money or postage producing agency to receive revenue by offering, for compensation, the right to advertise on legal tender or postage, permit a party to buy the right to advertise on monetary articles or postage, and permit advertisement of differently valued products to be targeted to certain consumers by placing the advertisement on a particular denomination of money or postage.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of advertising comprising the steps of:
receiving compensation from a party; and
placing an advertisement of the party on postage in exchange for the compensation received to advertise for the party.

2. The method of claim 1, wherein the step of placing an advertisement of the party on the postage is performed by printing the advertisement on the postage.

3. The method of claim 1, wherein the step of placing an advertisement of the party on the postage to promote the party includes promoting one or more of a good of the party and a service of the party.

4. The method of claim 1, wherein the step of placing an advertisement of the party on the postage is performed on more than one side of the postage.

5. The method of claim 1, wherein the step of placing an advertisement of the party on the postage is performed by disposing the advertisement within a margin of the postage.

6. The method of claim 1, wherein the method further comprises the step of using a color for the advertisement that is different from the color used to produce the postage prior to the advertisement being added.

7. The method of claim 1, wherein the advertisement of the party includes one or more of a logo, slogan, trademark, symbol, product, and contact information of the party.

8. The method of claim 1, wherein the method further comprises the step of correlating a denomination of the postage to a value of a product or service of the party.

9. A method of advertising comprising the steps of:
providing compensation to a postage maker; and
having an advertisement placed on the postage by the postage maker for the compensation provided to display the advertisement.

10. The method of claim 9, wherein the step of having an advertisement placed on the postage by the postage maker is performed by lithographically printing the advertisement on the postage.

11. The method of claim 9, wherein the step of providing compensation is performed by providing monetary compensation to the postage maker.

12. The method of claim 9, wherein the advertisement is placed on opposing sides of the postage.

13. The method of claim 9, wherein the step of having an advertisement placed on the postage by the postage maker is performed by situating the advertisement within a margin of the postage.

14. The method of claim 9, wherein the method further comprises the step of using a color for the advertisement not already present on the postage when the postage is made.

15. The method of claim 9, wherein the advertisement of the party includes one or more of a logo, slogan, trademark, product, and contact information of the party.

16. The method of claim 9, wherein the method further comprises the steps of requesting that the advertisement be placed on the postage and correlating a denomination of the postage to a value of a product or service of the party.

17. A method of advertising comprising the steps of:
correlating a party offering to a particular denomination of postage; and
placing an advertisement for the party offering on the particular denomination of postage to advertise the party offering.

18. The method of claim 17, wherein the method further comprises the step of receiving compensation for placing the advertisement for the party offering on the particular denomination.

19. The method of claim 18, wherein the method further comprises the step of offering to place the advertisement for the party offering the particular denomination of postage in exchange for compensation.

20. The method of claim 19, wherein the party offering is one or more of a product of the party, a service of the party, and a name of the party.
